(19) United States
(12) Patent Application Publication
(10) Pub. No.: US 2026/0208752 A1
(43) Pub. Date: Jul. 23, 2026

(54) METHOD FOR CHECKING THE PLAUSIBILITY OF A PARAMETER

(71) Applicant: ZF Friedrichshafen AG, Friedrichshafen (DE)

(72) Inventors: Matthias Madlener, Hohentengen (DE); Andreas Rothmund, Hohentengen (DE)

(73) Assignee: ZF Friedrichshafen AG, Friedrichshafen (DE)

(21) Appl. No.: 19/139,533

(22) PCT Filed: Nov. 20, 2023
(86) PCT No.: PCT/EP2023/082313

§ 371 Date: Jun. 16, 2025

(30) Foreign Application Priority Data
Dec. 16, 2022 (DE) 10 2022 213 783.3

(51) Int. Cl. B60W 50/02

(52) U.S. Cl. CPC B60W 50/0205; B60W 2050/0215; B60W 2510/081

(57) ABSTRACT

The invention relates to a method for checking the plausibility of a parameter involved in operation of a vehicle system, where the plausibility of the parameter sensed by a first sensor is checked by means of a second sensor, which likewise senses the parameter, by the examination of a first sensor signal (n(S₁)) from the first sensor with a second sensor signal (n(S₂)) from the second sensor. To make checking of the plausibility as reliable as possible, a differential signal (Δn) between the first sensor signal (n(S₁)) and the second sensor signal (n(S₂)) is formed and is compared with at least one threshold value (thd1, thd2). A measure is taken if the differential signal (Δn) exceeds the at least one threshold value (thd1, thd2) continuously for longer than a particular amount of time (tft1, tft2) associated with the at least one threshold value (thd1, thd2).

### RELATED APPLICATIONS

This application claims the benefit under 35 U.S.C. § 371 as a U.S. National Phase Application of application no. PCT/EP2023/082313, filed on 20 Nov. 2023, and which claims the benefit of German Patent Application no. 10 2022 213 783.3 filed on 16 Dec. 2022, the contents of which are hereby incorporated herein by reference in their entireties.

### FIELD OF THE DISCLOSURE

The invention relates to a method for checking the plausibility of a parameter involved in operation of a vehicle system of a motor vehicle, wherein the plausibility of the parameter sensed by a first sensor is checked by means of a second sensor, which likewise senses the parameter, by the examination of a first sensor signal from the first sensor with a second sensor signal from the second sensor. Furthermore, the invention relates to a control device, a computer program product, and a data carrier.

### BACKGROUND

Motor vehicles are usually equipped with vehicle systems designed to assist the driver when operating the vehicle. In some cases, a vehicle system also intervenes in the actual operation as a safety system in order to prevent critical operating conditions by performing safety functions or to ensure the safe operation of the motor vehicle in the event of malfunctions. Such a safety function is usually regulated or controlled on the basis of parameters sensed by corresponding sensors in the motor vehicle. However, since sensors can also fall or transmit incorrect information, which would result in the incorrect execution of the respective safety function, the reliable operation of the sensors must also be monitored when operating a safety system in a motor vehicle.

DE 10 2005 048 015 A1 describes a method for checking the plausibility of a parameter, wherein the method is applicable to a vehicle system of a motor vehicle, such as an ESP system, an airbag system, a driver assistance system (ACC), or similar. This involves determining a parameter that is necessary for controlling or regulating a respective function of the vehicle system, wherein DE 10 2005 048 015 A1 also specifies redundant monitoring as a possibility, in which a sensor signal from one sensor is checked using a respective other sensor signal.

### SUMMARY

Based on the prior art described above, the present invention aims to make the plausibility check of a parameter as simple and reliable as possible.

From a point of view of the method, this task is solved on the basis of the method disclosed herein in conjunction with its characteristic features. The present disclosure also relates to a control device with which the aforementioned method can be carried out, to a computer program product, and to a data carrier.

According to the invention, a parameter that is included in the operation of a motor vehicle system is validated in a method. The parameter sensed by a first sensor is checked for plausibility using a second sensor, which also senses the parameter, by comparing a first sensor signal from the first sensor with a second sensor signal from the second sensor.

In the method according to the invention, the parameter is therefore sensed by a first sensor and a second sensor, wherein the parameter is determined from a first sensor signal of the first sensor and its plausibility is checked using the second sensor. For the latter, the first sensor signal from the first sensor is checked against a second sensor signal from the second sensor.

Both sensors are used to directly sense the parameter, wherein this sensing is preferably taken independently of each other for plausibility checking. For this purpose, the two sensors are each provided in a corresponding area, for example, both directly on a component on which the parameter can be directly sensed.

The invention now comprises the technical teaching that the check is performed by forming a differential signal between the first sensor signal and the second sensor signal and comparing it with at least one threshold value. In addition, a measure is implemented if the differential signal continuously exceeds the at least one threshold value for longer than an amount of time assigned to the at least one threshold value. In other words, the first sensor signal is checked against the second sensor signal by generating a signal as the difference between the first sensor signal from the first sensor and the second sensor signal from the second sensor, and this differential signal is then compared with at least one threshold value. If the differential signal exceeds the at least one threshold value, a measure is initiated while the threshold value is exceeded and after an amount of time associated with the amount of time has elapsed.

The method according to the invention has the advantage that it allows the parameter to be checked for plausibility in a simple and reliable manner. This is because the formation of the differential signal and the comparison of this differential signal with the at least one threshold value makes it possible to check whether there is a deviation between the sensing of the parameter via the first sensor and the sensing of the parameter via the second sensor in a magnitude that indicates a discrepancy in the sensing, for example a measurement error or even a defect in one of the sensors or a defect in a cable. However, even if the differential signal exceeds the at least one threshold value, a measure is only initiated if the at least one threshold value is continuously exceeded for longer than a specified amount of time associated with the at least one threshold value. This prevents any unavoidable differences between the sensor signals, for example due to signal tolerances, read-in delays, etc., from leading to an erroneous conclusion that the parameter has been sensed incorrectly, and the corresponding measure being carried out. The respective amount of time thus represents a filter time.

According to one embodiment of the invention, the differential signal is compared with a first threshold value and a second threshold value, wherein the measure is carried out when the differential signal either exceeds the first threshold value continuously for longer than a first amount of time associated with the first threshold value or exceeds the second threshold value continuously for longer than a second amount of time associated with the second threshold value. This has the advantage of allowing different conditions to be defined for initiating the measure by assigning a suitable threshold value with a suitable amount of time to each condition.

In a further development of the aforementioned embodiment, the second threshold value was selected to be greater than the first threshold value and the first amount of time was selected to be greater than the second amount of time. This allows the first threshold value and the first amount of time to be used to define smaller deviations between the sensor signals as a reason for implementing the measure, although these deviations must be of longer duration. With the help of the second threshold value and the associated second amount of time, however, the measure can also be implemented if larger deviations between the sensor signals are sensed, wherein these larger deviations do not have to last as long as the first threshold value and the first amount of time. This can be used, for example, to sense a cable defect or similar.

As an alternative or supplement to the above-mentioned further development, the differential signal is compared with the first threshold value and the second threshold value in parallel. This has the advantage that, if one of the threshold values is exceeded continuously for a sufficiently long period, the measure is initiated immediately. Alternatively, the comparisons can also be performed consecutively by first comparing the differential signal with the first threshold value or by first comparing the differential signal with the second threshold value.

According to one embodiment of the invention, a request for emergency operation is generated as a measure, in which safe operation of the motor vehicle is carried out. If it is sensed that the differential signal continuously exceeds the at least one threshold value for longer than the amount of time assigned to the at least one threshold value, emergency operation is activated, in which safe operation of the motor vehicle is guaranteed in all cases. This ensures that discrepancies or errors in the sensing of the parameter cannot under any circumstances lead to unsafe driving conditions for the motor vehicle as a result of a corresponding regulation or control. In particular, emergency operation corresponds to the operation of the motor vehicle in which it is transferred even when at least one safety function of the vehicle system is triggered. In particular, in emergency operation, the drive torque of a drive motor of the motor vehicle is set to zero in order to prevent further propulsion of the motor vehicle via this drive motor from the moment emergency operation is initiated.

In a further development of the invention, a rotational speed, preferably a drive speed of a drive motor of the motor vehicle, is determined as a parameter. In this respect, the method according to the invention performs a plausibility check on these rotational speeds detected by two sensors in parallel, wherein at least one function of the vehicle system can then be controlled or regulated on the basis of the rotational speed. In particular, the sensed rotational speed is used to control or regulate at least one safety function of a safety system in a motor vehicle in the form of a construction machine.

The plausibility-checked parameter is incorporated into the operation of the vehicle system in particular by using this parameter for regulating or controlling at least one function of the safety system. The vehicle system is, in particular, a safety system for motor vehicles that can perform safety-related tasks in the form of at least one safety function in order to assist the driver in operating the motor vehicle and to prevent safety-critical driving conditions.

The motor vehicle is preferably a work vehicle, in particular a construction machine such as a wheel loader. In this case, safety functions are implemented via the vehicle system, which is preferably available as a safety system, in particular in the form of a function for preventing unintentional starting, a function for preventing unintentional starting in the wrong direction, and/or a function for preventing unintentional deceleration.

The invention also relates to a control device, in particular a transmission control device. This control device is designed to determine a parameter that can be included in the operation of a vehicle system. The control device is designed to sense the parameter via a first sensor and to verify its plausibility via a second sensor, which also senses the parameter. To this end, the control device checks a first sensor signal from the first sensor against a second sensor signal from the second sensor by forming a differential signal between the first sensor signal and the second sensor signal and comparing it with at least one threshold value. Furthermore, the control device is designed to perform a measure if the differential signal continuously exceeds the at least one threshold value for longer than an amount of time assigned to the at least one threshold value. Furthermore, the control device can then also be set up to implement one or more of the aforementioned variants of an method for operating a transmission order system according to the invention.

The method according to the invention can also be embodied as a computer program product which, when running on a processor, for example a processor of a aforementioned control device, instructs the processor by means of software to carry out the associated method steps according to the invention. In this context, the invention also includes a computer-readable medium on which a computer program product as described above is stored in a retrievable form.

### BRIEF DESCRIPTION OF THE DRAWINGS

Advantageous embodiments of the invention, which is discussed in the following, is shown in the drawings. These show in:

FIG. 1 Schematic view of a vehicle system;

FIG. 2 is a schematic representation of part of the vehicle system shown in FIG. 1;

FIG. 3 is a flow chart of a method according to the invention for plausibility checking of a parameter; and

FIG. 4 shows a diagram of an example of the progression of a differential signal in the method shown in FIG. 3.

### DETAILED DESCRIPTION

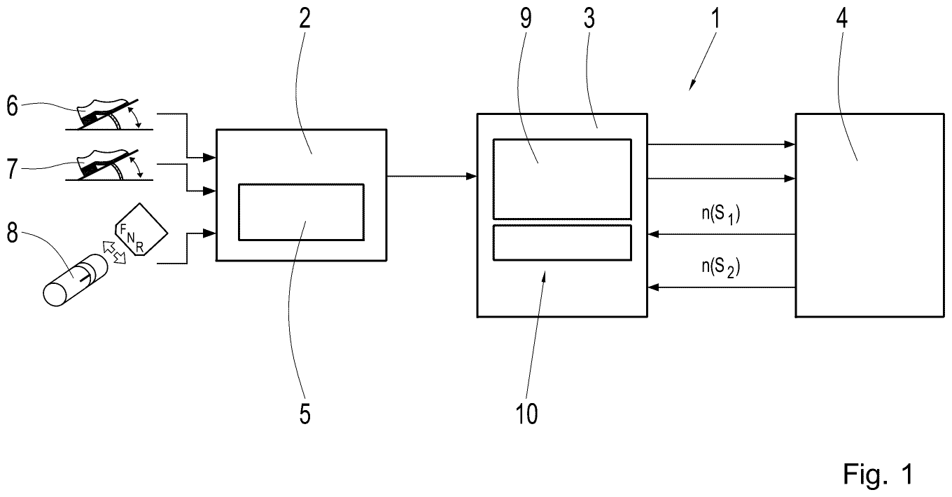

FIG. 1 shows a schematic view of a vehicle system 1, which is preferably intended for use in a motor vehicle in the form of a work vehicle, and here in particular for a construction machine. The motor vehicle is preferably designed as an electric vehicle and has a drive motor in the form of an electric motor, which is not described in further detail here, and which is in particular an asynchronous motor.

The vehicle system 1 comprises two control devices 2 and 3 and an inverter 4 of the electric machine (not shown), wherein the control devices 2 and 3 and the inverter 4 are connected to one another in a data bus system of the motor vehicle (CAN bus). The control device 2 is a vehicle computer (VCU) that can be used to control or regulate various functions 5 of the motor vehicle. For this purpose, the control device 2 is supplied with information about the respective positions of an accelerator pedal 6 and a brake pedal 7, as well as about the selection of a direction of travel at a travel direction switch 8.

The control device 3 is present as a transmission control device of a motor vehicle transmission (also not shown here), wherein the control device 3 is also supplied with information about the accelerator pedal positions and the selection of the direction of travel by the control device 2 within the data bus system. The control device 3 uses this information to regulate and control transmission functions 9, wherein the control device 3 also accesses the inverter 4 within the data bus system in order to set the required torque for the electric motor. On the other hand, the control device 3 together with the inverter 4 forms a safety system 10, by means of which various safety functions of the motor vehicle can be implemented. For the control and regulation of the transmission functions 9 and the safety functions, the inverter 4 communicates the current drive speed n of the electric motor to the control device 3 as a parameter. This drive speed n is determined independently at the electric motor via two sensors (not shown here) and transmitted to the control device 3 in the form of two sensor signals n(S₁) and n(S₂) as separate messages, which are each available as speed signals.

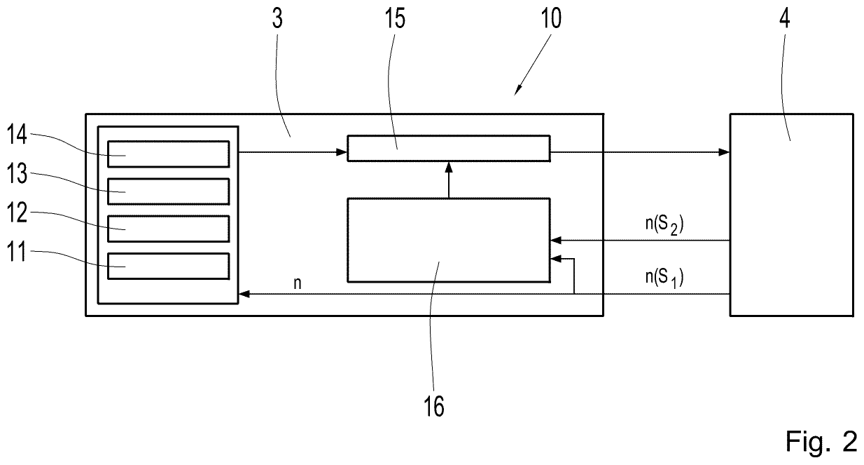

FIG. 2 shows a separate schematic diagram of the safety system 10 of the vehicle system 1 formed by the control device 3 and the inverter 4. Within the safety system 10, the current drive speed n is determined from the sensor signal n(S1) and used in various safety functions 11 through 14. These safety functions 11 through 14 may be, in particular, a function preventing the motor vehicle from starting unintentionally, a function preventing the motor vehicle from starting unintentionally in the wrong direction, a function preventing the motor vehicle from decelerating unintentionally, etc. If a safety-related event is sensed by the control device 3 in one of the safety functions 11 through 14, the control device 3 generates a request 15 for emergency operation of the motor vehicle. In this case, this requirement 15 is passed on to inverter 4 in order to set the target torque of the electric motor to zero.

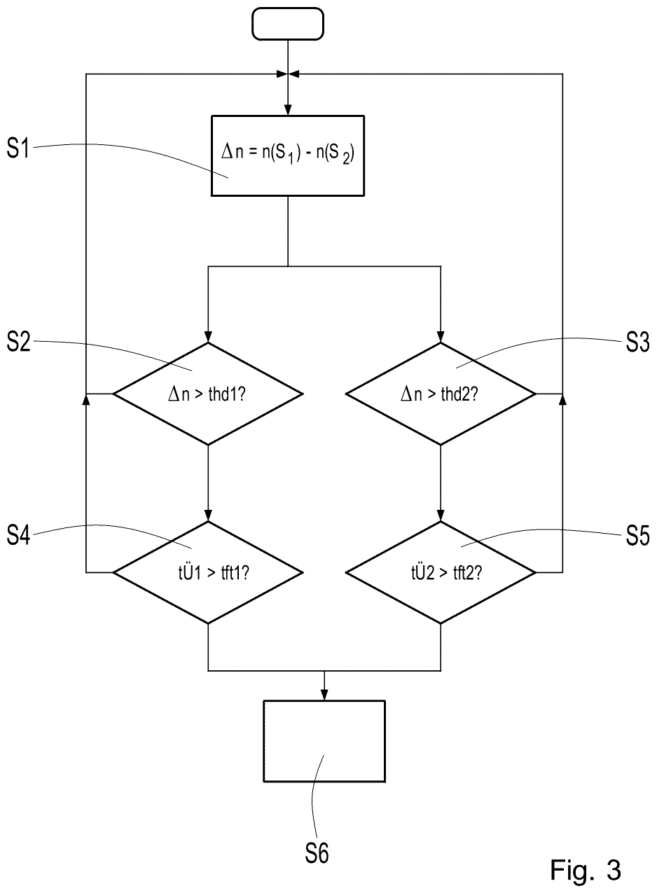

As part of a check 16, the two sensor signals n(S₁) and n(S₂) are also checked by the control device 3, wherein a check is performed on the respective status of the respective sensor signal n(S₁) or n(S₂). This check can be performed as part of a cyclic redundancy check (CRC). If an error is detected in the status of the respective sensor signal n(S₁) or n(S₂), request 15 for emergency operation is also generated and emergency operation is initiated by inverter 4. Secondly, the two sensor signals n(S₁) and n(S₂) are compared with each other in order to verify the plausibility of the sensor signal n(S₁). The latter is carried out within the scope of an invention-related method, which will now be described in more detail with the aid of FIG. 3, which shows a flow chart of the method.

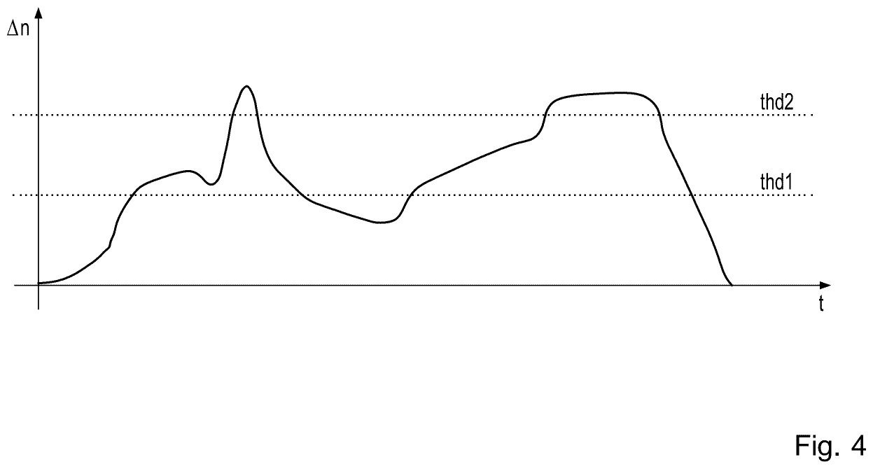

At the start of the method, the first step S1 is to generate a differential signal Δn as the difference between the two sensor signals n(S₁) and n(S₂), with an example of the progression of this differential signal Δn over time t shown in a diagram in FIG. 4. This differential signal Δn is then compared in parallel steps S2 and S3 with threshold values thd1 and thd2, respectively, both of which are also shown in FIG. 4. It can also be seen that the threshold value thd2 is set higher than the threshold value thd1. If in step S2, an exceedance of the threshold value thd1 is sensed by the differential signal Δn, then a step S4 is switched to, while otherwise a jump back before step S1. Similarly, step S3 is followed by step S5 if the threshold value thd2 is exceeded by the differential signal Δn in step S3. If this is not the case during the check, the program also jumps back to step S1 after step S3.

If, on the other hand, exceeding the threshold value thd1 was detected in step S2, the next step in step S4 is to check whether a sensed time tÜ1 of continuous, i.e., uninterrupted, exceeding of the threshold value thd1 is longer than an amount of time tft1. If this is not the case, the process returns to step S1, otherwise it proceeds to step S6.

In step SS, which is entered after step S3 when the threshold value thd2 is exceeded by the differential signal Δn, a time tÜ2 is also determined, which represents the duration of the continuous exceeding of the threshold value thd2 by the differential signal Δn. This time tÜ2 is then compared with an amount of time tft2 in step S5, wherein if the amount of time tft2 is exceeded by the time tÜ2, the process proceeds to step S6, otherwise it jumps back to step S1. The amount of time tft2 is shorter than the amount of time tft1, so that a shorter time tÜ2 is required for a transition from step S5 to step S6 compared to the time tÜ1.

If, during one of the parallel pairs of steps S2 and S4 and S3 and S5, it is sensed that the differential signal Δn continuously exceeds the respective threshold value thd1 or thd2 continuously exceeds the respective associated amount of time tft1 or tft2, a relevant deviation between the speed signals n(S₁) and n(S₂) is sensed in step S6 and a measure is subsequently initiated. As part of this measure, requirement 15 for emergency operation of the motor vehicle is also generated and forwarded to the inverter 4, so that step S6 ensures safe operation of the motor vehicle.

The method according to the invention enables reliable plausibility checking of a parameter to be carried out.

### REFERENCE NUMBERS

1 vehicle system
2 control device
3 control device
4 inverter
5 functions
6 accelerator pedal
7 brake pedal
8 travel direction switch
9 transmission functions
10 safety system
11 safety function
12 safety function
13 safety function
14 safety function
15 requirement for emergency operation
16 review
n drive speed
n(S₁) sensor signal
n(S₂) sensor signal
Δn differential signal
t time
thd1 threshold value
thd2 threshold value
tÜ1 time
tÜ2 time
tft1 amount of time
tft2 amount of time
S1 through S6 individual steps

1. A method for checking the plausibility of a parameter involved in operation of a vehicle system of a motor vehicle, comprising:
checking the plausibility of the parameter sensed by a first sensor by means of a second sensor, wherein the second sensor likewise senses the parameter, by the examination of a first sensor signal (n(S₁)) from the first sensor with a second sensor signal (n(S₂)) from the second sensor wherein checking the plausibility comprises:
forming a differential signal (Δn) between the first sensor signal (n(S₁)) and the second sensor signal (n(S₂));
comparing the differential signal with at least one threshold value (thd1, thd2); and
determining that the differential signal (Δn) exceeds the at least one threshold value (thd1, thd2) continuously for longer than a particular amount of time (tft1, tft2) associated with the at least one threshold value (thd1, thd2); and
taking a measure.

2. The method according to claim 1, comprising:
comparing the differential signal (Δn) with a first threshold value (thd1) and a second threshold value (thd2);
wherein the measure is carried out when the differential signal (Δn) either exceeds the first threshold value (thd1) continuously for longer than a first amount of time (tft1) associated with the first threshold value (thd1) or exceeds the second threshold value (thd2) continuously for longer than a second amount of time (tft2) associated with the second threshold value (thd2).

3. The method according to claim 2, wherein the second threshold value (thd2) is selected to be greater than the first threshold value (thd1) and the first amount of time (tft1) is selected to be greater than the second amount of time (tft2).

4. The method according to claim 2, wherein comparing the differential signal (Δn) with the first threshold value (thd1) and with the second threshold value (thd2) are performed in parallel.

5. The method according to claim 1, comprising generating a request (15) for emergency operation as the measure, in which safe operation of the motor vehicle is carried out.

6. The method according to claim 1, comprising determining a rotational speed of a drive motor of the motor vehicle as a parameter.

7. The method according to claim 6, comprising incorporating the parameter into a control or a control system for at least one safety function of the vehicle system (1).

8. A transmission control device (3) configured to determine a parameter which can be incorporated during operation of a vehicle system (1), wherein the control device (3) is configured to detect the parameter via a first sensor and to check the plausibility of the parameter via a second sensor which also detects the parameter, for which purpose the control device (3) inspects a first sensor signal (n(S₁)) of the first sensor with a second sensor signal (n(S₂)) of the second sensor by forming a differential signal (Δn) between the first sensor signal (n(S₁)) and the second sensor signal (n(S₂)) and comparing it with at least one threshold value (thd1, thd2), and wherein the control device (3) is configured to carry out a measure if the difference signal (Δn) continuously exceeds the at least one threshold value (thd1, thd2) for longer than an amount of time (tft1, tft2) associated with the at least one threshold value (thd1, thd2).

9. The control device according to claim 8, wherein the control device is further configured to carry out the method according to claim 2.

10. A computer program product for the control device (3) according to claim 8, the computer program product including executable code that is configured to check the plausibility of a parameter implemented by the following steps:
checking the plausibility of the parameter sensed by a first sensor by means of a second sensor, wherein the second sensor likewise senses the parameter by the examination of a first sensor signal (n(S₁)) from the first sensor with a second sensor signal (n(S₂)) from the second sensor wherein checking the plausibility comprises:
forming a differential signal (Δn) between the first sensor signal (n(S₁)) and the second sensor signal (n(S₂));
comparing the differential signal with at least one threshold value (thd1, thd2); and
determining that the differential signal (Δn) exceeds the at least one threshold value (thd1, thd2) continuously for longer than a particular amount of time (tft1, tft2) associated with the at least one threshold value (thd1, thd2); and
taking a measure.

11. A data carrier with a computer program product according to claim 10.
